(19) United States
(12) Patent Application Publication
(10) Pub. No.: US 2014/0173465 A1
(43) Pub. Date: Jun. 19, 2014

(54) Virtual memorial park with plots and memorials

(71) Applicant: Lawrence Parmelee Greenman, Gold Coast (AU)

(72) Inventor: Lawrence Parmelee Greenman, Gold Coast (AU)

(21) Appl. No.: 13/713,006

(22) Filed: Dec. 13, 2012

(51) Int. Cl. G06F 3/0481

(52) U.S. Cl. CPC G06F 3/04815
USPC 715/757

(57) ABSTRACT

By locating the traditional memorial park within a virtual world, it allows for the placement and access by visitors of virtual memorial plots and virtual memorials, from any country, and at any time, independent of weather conditions and outside the realm of physical decay. The virtual memorial park can be subdivided into categories of virtual memorial parks, which allows for improved special interest group affiliations re the virtual memorial plots and virtual memorials. The location of virtual memorial parks and virtual memorials within three dimensional graphic and two dimensional graphic virtual terrains, allows for the visitor to have a ‘real life’ simulation, as to the virtual terrain, without the need to consume additional valuable land and space.

### CROSS-REFERENCE TO RELATED APPLICATIONS

not applicable.

### STATEMENT REGARDING FEDERALLY SPONSORED RESEARCH & DEVELOPMENT

not applicable.

### REFERENCE TO SEQUENCE LISTING, A TABLE, OR A COMPUTER PROGRAM LISTING COMPACT DISC APPENDIX

not applicable

### BACKGROUND OF THE INVENTION

Memorial parks to date, have largely been physical land-based locations, subdivided into plots with memorial/s to deceased persons or groups of people, which allow visitors to approach these plots with their memorials, on foot. These memorial parks are generally open to the weather, and the environment at large.

The invention lies in transposing the traditional memorial park into a virtual memorial park, located on the internet. The virtual memorial park would duplicate all the essential functions of the traditional land-based memorial park, including such features as memorials, plot layouts and personal content via family and friend dedications. The virtual memorial park with plots, solves several problems related to the traditional memorial park. Traditional land-based memorial parks with memorials, have limited access (a visitor needs to be in the local physical area), are open to weather and associated decay/damage, and they often require land, which is often in very short supply in large urban centers. A virtual memorial park with plots, allows for essential relationships between loved-ones to be retained, allows visitor access from a global perspective, frees-up ground for other urban uses, and reduces the costs associated with maintenance, and it ensures data is not lost through sustained weathering or dereliction.

### BRIEF SUMMARY OF THE INVENTION

The essential component of the virtual memorial park is preferably a gridded plane, where individual virtual memorial plots are located.

Furthermore, various categories of virtual memorial park have been invented which allow the deceased to be represented in several categories of virtual memorial park.

The virtual memorial parks are either two dimensional graphic planes with virtual plots indicated, or graphically represented three-dimensional virtual worlds, with virtual plots overlaid. Virtual memorials are located within the virtual memorial parks or virtual worlds, in which the virtual memorial parks are located.

### BRIEF DESCRIPTION OF THE DRAWINGS

FIG. 1 illustrates in plan view, an embodiment of a virtual plot, for location within a virtual memorial park.

FIG. 2 illustrates in plan view, an embodiment of a virtual memorial park with several plots, per FIG. 1, represented. Plot numbers can be infinite, and they can extend in all directions.

### DETAILED DESCRIPTION OF THE INVENTION

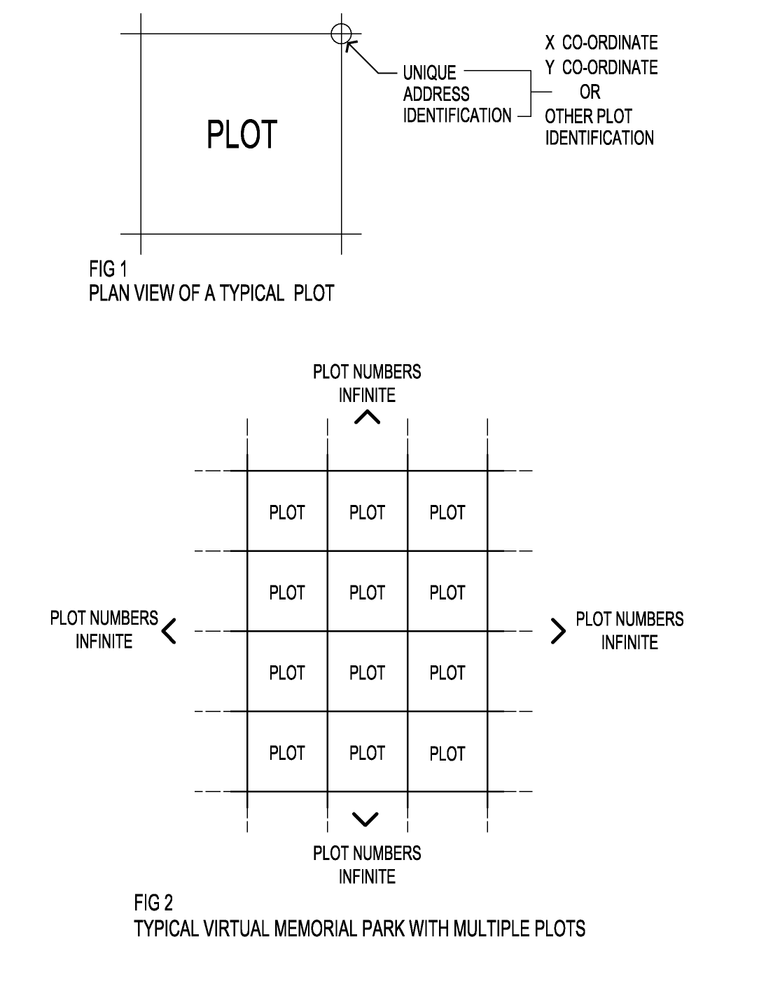

The invention lies in transposing the traditional memorial park into a virtual memorial park, located on the internet. The virtual memorial park would duplicate all the essential functions of the traditional land-based memorial park, including such features as memorials, plot layouts and personal content via family and friend dedications. FIG. 1 represents a version of a virtual plot, drawn as a typical grid, with and ‘x’ and a ‘y’ dimension. Virtual plot configurations are limitless as to graphic expression and representation.

Furthermore, the virtual memorial park may be represented as a two dimensional graphic plane, with a gridded ‘overlay’ representing the virtual memorial plots in FIG. 2, or the virtual memorial park could be a graphic three-dimensional virtual world, overlaid with a gridded layout of virtual memorial plots, or the virtual memorial park could be individual independent virtual plots, or stand alone virtual memorials, located within a graphic three-dimensional virtual world, or other essential embodiments of the principles as outlined herein. The invention is the location of virtual plots within two dimensional graphic or three dimensional graphic virtual memorial parks, for purposes of the memorialization of deceased individuals or individuals within broader virtual memorial park categories, allowing for areas of commonality amongst the individuals.

The invention claimed is the subdivision of memorial parks into categories of virtual memorial park, which would cover, amongst other variations, but in particular a ‘world view virtual memorial park’, ‘trans-national/transcultural group affiliation virtual memorial parks’, ‘group affiliation virtual memorial parks’, ‘family-view virtual memorial parks’ and ‘personal view virtual memorial parks’. The virtual memorial plots which are located within a single specific virtual memorial park, could be duplicated to other memorial park categories, allowing for the deceased's content, to be replicated and accessible to different user groups. The invention of limitless categories of memorial park, increases the ‘community’ options, lacking from traditional memorial parks. Virtual memorial park categories, such as ‘Family and Friends’ is a user specific memorial park, whereas the memorial park category, “world-view’, would be representative of a ‘fully democratic’, accessible to all, virtual memorial park.

Each virtual memorial plot would house a virtual memorial, or multiple virtual memorials, with the personal details of the deceased people/persons. The memorial plots are thus seen as ‘family’ plots, or ‘group plots’, depending upon the needs of the user.

The virtual memorial parks are limitless in terms of appearance and plot configuration. Thus it is intended that the present invention cover the modifications and variations of this invention that come with the scope of the appended claims and their equal.

1. the invention claimed is a virtual memorial park, subdivided into virtual memorial plots, each with one or several virtual memorials dedicated to the deceased.

2. The invention claimed is that the virtual memorial parks are either two dimensional graphic planes with virtual plots indicated, or three-dimensional graphic virtual worlds, with virtual plots overlaid.

3. The invention claimed is the subdivision of memorial parks into categories of virtual memorial park, which would cover, amongst other variations, but in particular a ‘world view virtual memorial park’, ‘trans-national/transcultural group affiliation virtual memorial parks’, ‘ group affiliation virtual memorial parks’, ‘family-view virtual memorial parks’ and ‘personal view virtual memorial parks’.
